(19) United States
(12) Patent Application Publication
(10) Pub. No.: US 2008/0184147 A1
(43) Pub. Date: Jul. 31, 2008

(54) METHOD AND SYSTEM TO LOOK AHEAD WITHIN A COMPLEX TAXONOMY OF OBJECTS

(75) Inventors: Mark A. Anderson, Cary, NC (US); Rosalind Radcliffe, Durham, NC (US); Jean N. Shortley, Raleigh, NC (US); Peter S. Wassel, Apex, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/669,303

(22) Filed: Jan. 31, 2007

(51) Int. Cl. G06F 3/048; G06F 3/00; G06F 3/033; G06F 3/14

(52) U.S. Cl. 715/768; 715/854; 715/808; 715/862

(57) ABSTRACT

A method for providing a graphical user interface (GUI), where the GUI allows a user to look ahead to object relationships at the additional navigational layers in a taxonomy, without navigating to other layers in the taxonomy, wherein the method includes: selecting an object on a display screen to view the objects context at another layer in the taxonomy; providing the user with a pop-up taxonomy menu; selecting from the pop-up taxonomy menu a layer within the taxonomy to see the selected object's context in relation to additional objects of the taxonomy; providing the user a window display in the area of the selected object; wherein the window displays the current object selected in relationship and in context to the additional objects at the selected layer in the taxonomy; and does not obscure or replace an original view or the selected object.

### TRADEMARKS

IBM® is a registered trademark of International Business Machines Corporation, Armonk, N.Y., U.S.A. Other names used herein may be registered trademarks, trademarks or product names of International Business Machines Corporation or other compares.

### BACKGROUND OF THE INVENTION

1. Field of the Invention

This invention relates generally to graphical user interfaces, and more particularly to systems and methods for enabling a user to navigate through a taxonomy using a translucent display that maintains the current view of an object while also allowing the user to drill down and look ahead and display the object in relationship to other entities in the layers.

2. Description of the Related Art

Conducting a traditional drill down on an object to its next logical layer in a multi-layer information technology (IT) structure, the user must leave the current view of the object to view the object in its next layer in a taxonomy. As a result, the current context of the object is no longer visible to the user when the user is at the next layer of the taxonomy. Current solutions provide drill down at the expense of replacing the current view with the drilled down view. Histories, links (breadcrumbs) are available to go back to the original view; however the user must mentally maintain the prior view when doing a drill down. In today's complex IT infrastructures, applications, and technologies, customers are requesting that more information be available to them at one time to diagnose or ascertain the state of their system. However, display size constraints and the size of mobile computing and communication devices have effectively limited the ability to display multiple levels of information.

### SUMMARY OF THE INVENTION

A method for providing a graphical user interface (GUI) on information, communication, and computing devices, where the GUI allows a user to look ahead to object relationships at the additional navigational layers in a taxonomy, without navigating to other layers in the taxonomy, wherein the method includes: selecting an object on a display screen to view the object's context at another layer in the taxonomy; providing the user with a pop-up taxonomy menu in response to the user selecting the object; selecting from the pop-up taxonomy menu a layer within the taxonomy to see the selected object's context in relation to additional objects of the taxonomy; providing the user a window display in the area of the selected object in response to the layer selected from the pop-up taxonomy menu; wherein the window displays the current object selected in relationship to the additional objects at the selected layer in the taxonomy; and wherein the window display does not obscure or replace an original view or the selected object, but enables the user to “look ahead” into the selected layer without losing context in relation to the selected object.

A system for providing a graphical user interface (GUI), where the GUI allows a user to look ahead to object relationships at the additional navigational layers in a taxonomy, without navigating to other layers in the taxonomy, the system includes; computing devices; communication devices; information appliances; a network; wherein the computing devices further comprise at least one of the following: computer servers; mainframe computers; desktop computers; and mobile computing devices; and wherein at least one of the computing devices, communication devices, and information appliances is configured to execute electronic software that manages the GUI; and wherein the electronic software is resident on a storage medium in signal communication with at least one of the computing devices, communication devices, and information appliances; and wherein at least one of the computing devices, communication devices, and information appliances is in signal communication with the network; and wherein the network further comprises at least one of the following: local area network (LAN); wide area network (WAN); a global network; the Internet; an intranet; wireless networks; and cellular networks; and wherein the electronic software facilitates a GUI that allows a user to look ahead to object relationships at the additional navigational layers in the taxonomy, without navigating to other layers in the taxonomy.

An article comprising machine-readable storage media containing instructions that when executed by a processor enable the processor to manage a graphical user interface (GUI) on information, communication, and computing devices, where the GUI allows a user to look ahead to object relationships at the additional navigational layers in a taxonomy, without navigating to other layers in the taxonomy, wherein the instructions include: software code for providing objects on a display screen that allow a user select an object and to view the object's context at another layer in the taxonomy; software code for providing the user with a pop-up taxonomy menu in response to the user selecting the object, wherein the user selects from the pop-up taxonomy menu a layer within the taxonomy to see the selected object's context in relation to additional objects of the taxonomy; software code providing the user a window display in the area of the selected object in response to the layer selected from the pop-up taxonomy menu; wherein the window displays the current object selected in relationship to the additional objects at the selected layer in the taxonomy; and wherein the window display does not obscure or replace an original view or the selected object, but enables the user to “look ahead” into the selected layer without losing context in relation to the selected object.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a system and method for providing a graphical user interface that enables a user to navigate through a taxonomy using a translucent display that maintains the current view of an object while also allowing the user to drill down and look ahead and display the object in relationship to other entities in the layers.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a representation of a graphical user interface (GUI) according to an embodiment of the invention.

FIG. 2 illustrates a flowchart of user and GUI interaction according to an embodiment of the invention.

FIG. 3 illustrates a system for implementing the GUI according to an embodiment of the invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a system and method for a graphical user interface that enables a user to navigate through a taxonomy using a translucent display that maintains the current view of an object while also allowing the user to drill down and look ahead and display the object in relationship to other entities in the layers. When the user selects an object that the user would like to view at a different layer in the taxonomy, a pop up taxonomy is displayed wherein the user can select the layer. A new transparent window is displayed wherein the current object is displayed in relationship to other objects at the selected layer without losing context of the current layer.

The method to look ahead within a complex taxonomy of objects according to embodiments of the present invention provides a translucent view that allows a user to “look ahead” to object relationships at the next navigational layer in the taxonomy. The user has the ability to “look ahead” to derive information from multiple objects in the taxonomy without navigating to other layers in the taxonomy, thereby not obscuring the current view. With the present invention the user sees the current object and its relationship to other objects in another layer in the taxonomy, while at the same time maintaining the current view. The GUI provides the user with just the layer selected above or below the current object without losing the current view.

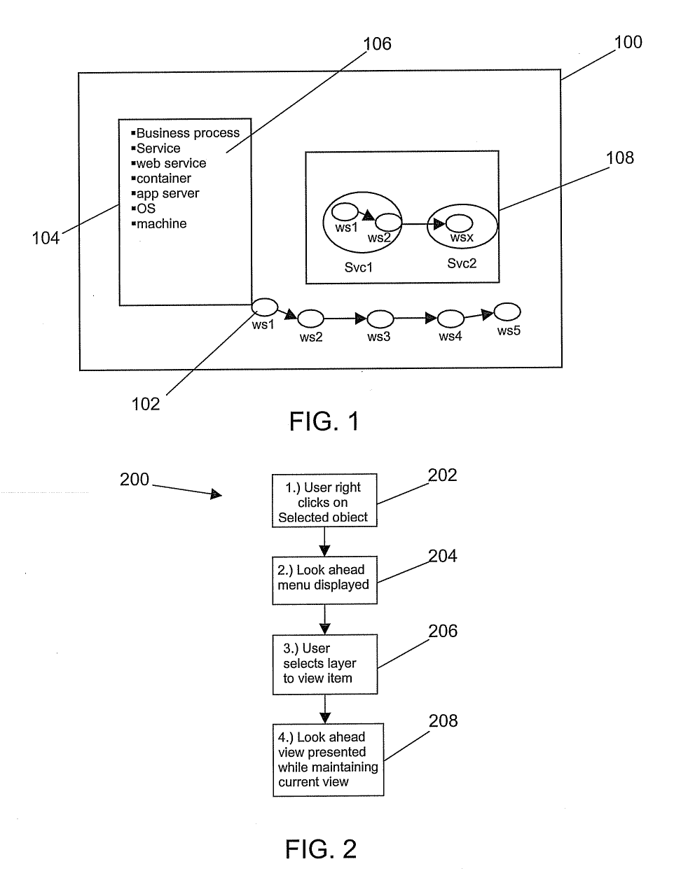

FIG. 1 illustrates a display screen 100 with a GUI implementing an embodiment of the present invention in conjunction with a flow diagram 200 of FIG. 2 that describes the user and GUI interaction according to an embodiment of the invention. The example presented in FIGS. 1 and 2 represents a taxonomy that is an IT stack, which includes a Services Oriented Architecture using Web Services. Through a graphical representation of a web service in a topology view 100, the user selects an object with a pointing device (102, 202). Examples of a pointing device would be a mouse (right clicking on the object to select), a stylus for a touch screen, or a light pen. In response to the object selected the GUI 100 provides a pop-up taxonomy menu (104, 204) that provides a “look ahead.” The user selects (106, 206) which layer within the taxonomy the user would like to see the selected object's context to other objects (i.e. drill down). Upon selection of the layer, a new transparent window (108, 208) is displayed near the current object. The new transparent view displays the current object selected in relationship to other objects at the next layer in the taxonomy (either above or below one or several layers from the current layer in the taxonomy). The translucent display or alternate window does not obscure or replace the original view or selected object, but enables the user to “look ahead” into the selected layer without losing context.

An example application of the embodiment of the invention illustrated in FIGS. 1 and 2 could be a user viewing a graph of a file system containing directories and files, which is represented by a traditional tree structure graph. Each file has relationships to other objects besides being contained in the directory in which it resides. For example, another graph could show the relationship of the file to the set of people who have edited the file, or its relationship to all references to that file in other documents, or its relationship to all shortcuts that reference that file. Instead of double-clicking the file to “drill” into another graph showing these other relationships, a context menu for the file could show a flyout translucent “look ahead” view (104) to present the graphs of the other relationships that file has with these other objects.

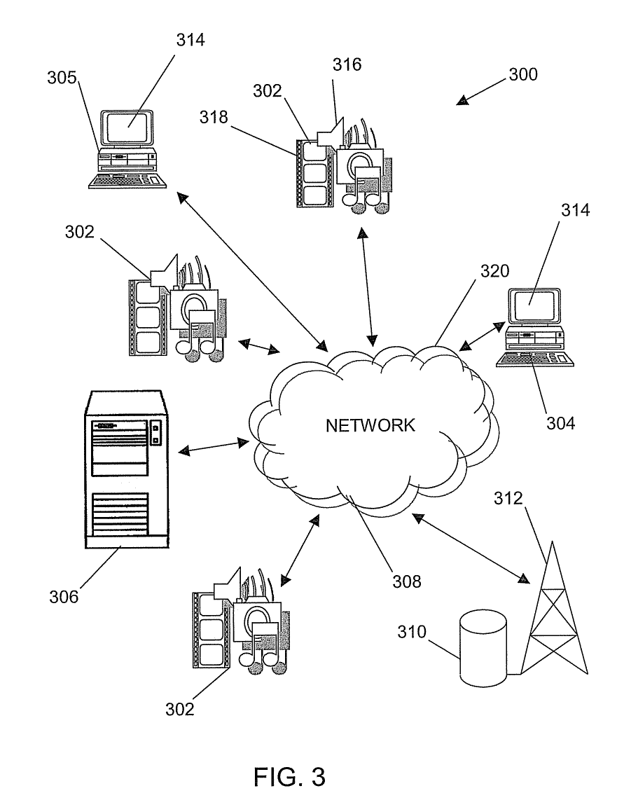

FIG. 3 is a block diagram of an exemplary system 300 for implementing the GUI of the present invention and graphically illustrates how those blocks interact in operation. The system 300 includes remote devices including one or more multimedia/communication devices 302 equipped with speakers 316 for implementing the audio, as well as display capabilities 318 for facilitating the graphical user interface (GUI) aspects of the present invention. In addition, mobile computing devices 304 and desktop computing devices 305 equipped with displays 314 for use with the GUI of the present invention are also illustrated. The remote devices 302 and 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 302 and 304 may be implemented using a general-purpose computer executing a computer program for carrying out the GUI described herein. The computer program may be resident on a storage medium local to the remote devices 302 and 304, or may be stored on the server system 306 or cellular base station 310. The server system 306 may belong to a public service. The remote devices 302 and 304, and desktop device 305 may be coupled to the server system 306 through multiple networks (e.g., intranet and Internet) so that not all remote devices 302, 304, and desktop device 305 are coupled to the server system 306 via the same network. The remote devices 302, 304, desktop device 305, and the server system 306 may be connected to the network 308 in a wireless fashion, and network 308 may be a wireless network. In a preferred embodiment, the network 308 is a LAN and each remote device 302, 304 and desktop device 305 executes a user interface application (e.g., web browser) to contact the server system 306 through the network 308. Alternatively, the remote devices 302 and 304 may be implemented using a device programmed primarily for accessing network 308 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing a graphical user interface (GUI) on information, communication, and computing devices, where the GUI allows a user to look ahead to object relationships at additional navigational layers in a taxonomy, without navigating to other layers in the taxonomy, wherein the method comprises:
selecting an object on a display screen to view the objects context at another layer in the taxonomy;
providing the user with a pop-up taxonomy menu in response to the user selecting the object;
selecting from the pop-up taxonomy menu a layer within the taxonomy to see the selected object's context in relation to additional objects of the taxonomy;
providing the user a window display in the area of the selected object in response to the layer selected from the pop-up taxonomy menu;
wherein the window displays the current object selected in relationship to the additional objects at the selected layer in the taxonomy; and
wherein the window display does not obscure or replace an original view or the selected object, but enables the user to “look ahead” into the selected layer without losing context in relation to the selected object.

2. The method of claim 1, wherein the providing of a window display is facilitated by a transparent window.

3. The method of claim 1, wherein the providing of a window display is facilitated by a translucent window.

4. The method of claim 1, wherein the selecting is facilitated by a pointing device.

5. The method of claim 1, wherein the selecting is facilitated by a mouse.

6. The method of claim 1, wherein the selecting is facilitated by a stylus.

7. The method of claim 1, wherein the selecting is facilitated by a light pen.

8. The method of claim 1, wherein the selecting is facilitated by the user touching the display screen.

9. A system for providing a graphical user interface (GUI), where the GUI allows a user to look ahead to object relationships at additional navigational layers in a taxonomy, without navigating to other layers in the taxonomy, the system comprising;
computing devices;
communication devices;
information appliances;
a network;
wherein the computing devices further comprise at least one of the following:
computer servers;
mainframe computers;
desktop computers; and
mobile computing devices; and
wherein at least one of the computing devices, communication devices, and information appliances is configured to execute electronic software that manages the GUI; and
wherein the electronic software is resident on a storage medium in signal communication with at least one of the computing devices, communication devices, and information appliances; and
wherein at least one of the computing devices, communication devices, and information appliances is in signal communication with the network; and
wherein the network further comprises at least one of the following:
local area network (LAN);
wide area network (WAN);
a global network;
the Internet;
an intranet;
wireless networks; and
cellular networks; and
wherein the electronic software facilitates a GUI that allows a user to look ahead to object relationships at the additional navigational layers in the taxonomy, without navigating to other layers in the taxonomy.

10. The system of claim 9, wherein the GUI facilitates the user selecting an object on a display screen to view the objects context at another layer in the taxonomy, and provides the user with a pop-up taxonomy menu in response to the user selecting the object, and allows the user to select from the pop-up taxonomy menu a layer within the taxonomy to see the selected object's context in relation to additional objects of the taxonomy, and provides the user a window display in the area of the selected object in response to the layer selected from the pop-up taxonomy menu;
wherein the window displays the current object selected in relationship to the additional objects at the selected layer in the taxonomy; and
wherein the window display does not obscure or replace an original view or the selected object, but enables the user to “look ahead” into the selected layer without losing context in relation to the selected object.

11. The system of claim 9, wherein the providing of a window display is facilitated by a transparent window.

12. The system of claim 9, wherein the providing of a window display is facilitated by a translucent window.

13. The system of claim 9, wherein the selecting is facilitated by a pointing device.

14. The system of claim 9, wherein the selecting is facilitated by a mouse.

15. The system of claim 9, wherein the selecting is facilitated by a stylus.

16. The system of claim 9, wherein the selecting is facilitated by a light pen.

17. The system of claim 9, wherein the selecting is facilitated by the user touching the display screen.

18. An article comprising machine-readable storage media containing instructions that when executed by a processor enable the processor to manage a graphical user interface (GUI) on information, communication, and computing devices, where the GUI allows a user to look ahead to object relationships at additional navigational layers in a taxonomy, without navigating to other layers in the taxonomy, wherein the instructions comprise:
software code for providing objects on a display screen that allow a user select an object and to view the objects context at another layer in the taxonomy;
software code for providing the user with a pop-up taxonomy menu in response to the user selecting the object, wherein the user selects from the pop-up taxonomy menu a layer within the taxonomy to see the selected object's context in relation to additional objects of the taxonomy;
software code providing the user a window display in the area of the selected object in response to the layer selected from the pop-up taxonomy menu;
wherein the window displays the current object selected in relationship to the additional objects at the selected layer in the taxonomy; and
wherein the window display does not obscure or replace an original view or the selected object, but enables the user to “look ahead” into the selected layer without losing context in relation to the selected object.
